(19) United States
(12) Patent Application Publication
(10) Pub. No.: US 2011/0165927 A1
(43) Pub. Date: Jul. 7, 2011

(54) Video Poker Game with a Hedging Operation

(76) Inventor: Geoff Hall, Solihull (GB)

(21) Appl. No.: 12/963,635

(22) Filed: Dec. 9, 2010

Related U.S. Application Data
(60) Provisional application No. 61/288,288, filed on Dec. 19, 2009.

(51) Int. Cl. G06F 19/00

(52) U.S. Cl. 463/13

(57) ABSTRACT

A method, system, and computer readable storage medium to provide a variation of a video poker game. The video poker game offers the player an ability to split the initial hand into two identical initial hands. The player is then free to play out each of the two identical initial hands in different manners. In this way, a player that cannot decide how to player a particular hand can now player that hand in two different ways.

### CROSS REFERENCE TO RELATED APPLICATIONS

This application claims benefit to U.S. provisional application No. 61/288,288, filed on Dec. 19, 2009, which is incorporated by reference in its entirety for al purposes.

### BACKGROUND OF THE INVENTION

1. Field of the Invention

The present inventive concept relates to a system, method, and computer readable storage, for playing a variation of the known game of video poker.

2. Description of the Related Art

Video poker games are well known the art. What is needed is a video poker game that gives a player more exciting options than are currently available.

### SUMMARY OF THE INVENTION

It is an aspect of the present general inventive concept to provide an exciting improvement over video poker.

The above aspects can also be obtained by a method that includes (a) executing instructions to perform the following operations on a processing unit: (b) receiving, on the electronic gaming machine, an initial wager from a player; (c) dealing a player's first hand comprising five cards; (d) receiving an instruction by the player to duplicate the initial hand; (e) duplicating the first hand as a second hand; (f) allowing the player to select hold cards in the first hand and the second hand; (g) replacing non-hold cards in the first hand and the second hand with new cards to form a first final hand and a second final hand; (h) awarding any earned first payout, on the electronic gaming machine, to the player based on a rank of the first final hand; and (i) awarding any earned second payout, on the electronic gaming machine, to the player based a rank of the second final hand.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating the prior art game of video poker;

FIG. 2 is a drawing of one example of a video poker machine that can be used to implement methods herein, according to an embodiment;

FIG. 3 is a flowchart illustrating an exemplary method of offering a hedge option during a video poker game, according to an embodiment;

FIG. 4 is a flowchart illustrating a second exemplary method of offering a hedge option during a video poker game, according to an embodiment;

FIG. 5A is a drawing illustrating a first phase in an illustrative game, according to an embodiment;

FIG. 5B is a drawing illustrating a second phase in an illustrative game, according to an embodiment;

FIG. 6A is a drawing illustrating a third phase in an illustrative game, according to an embodiment;

FIG. 6B is a drawing illustrating a fourth phase in an illustrative game, according to an embodiment;

FIG. 7A is a drawing illustrating a first final phase in an illustrative game, according to an embodiment;

FIG. 7B is a drawing illustrating a second final phase in an illustrative game, according to an embodiment; and

FIG. 8 is a block diagram illustrating hardware that can be used to implement the wagering methods, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The general inventive concept relates to a game involving video poker. Video poker is a well known game in the art, for example see U.S. Pat. No. 6,569,014, which is incorporated by reference here in its entirety. The present inventive concept relates to a hedging (or duplicating) operation that allows the player (at his or her option) to duplicate the initial hand dealt into two identical initial hands. The player can then play out each hand in a different manner. In this fashion, when a player cannot decide how to play a particular hand out of two possible strategies, the player can split up the hand into two hands and then play the hand in both fashions. The initial wager placed on the game can be divided in half, one half for each of the split hands. Thus, each final hand of the two hands will pay one half of what the original game would pay if the player did not split the hand.

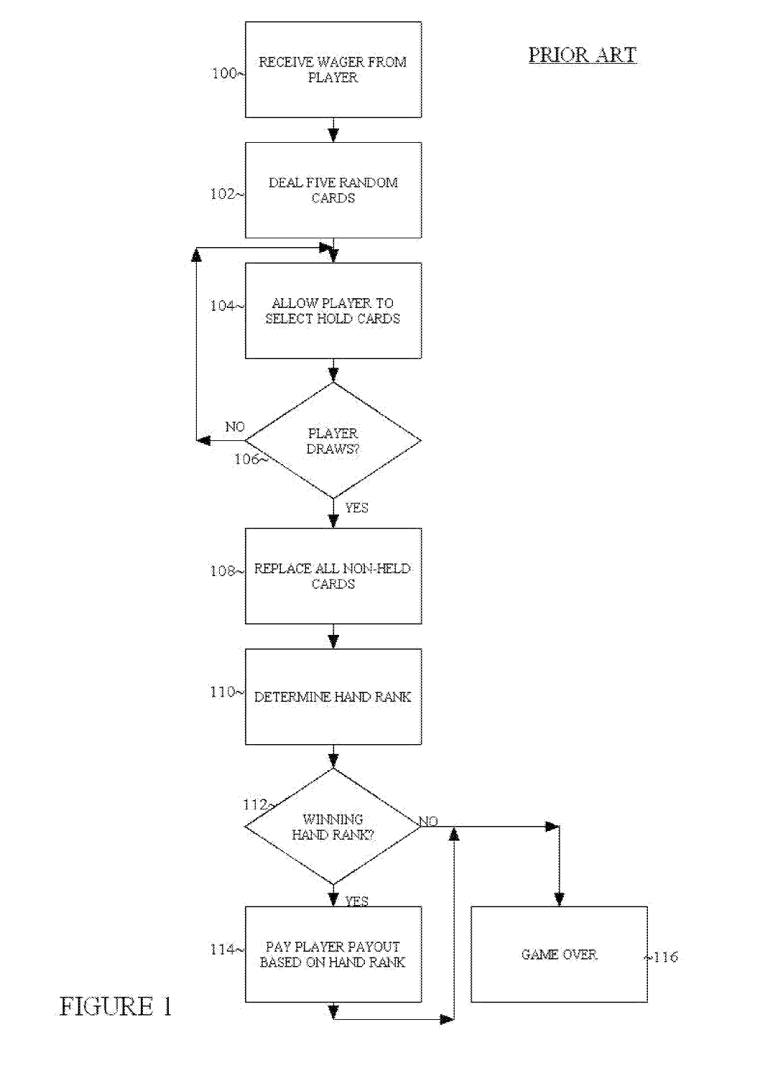

FIG. 1 is a flowchart illustrating the prior art game of video poker. The goal is for the player to form the highest ranking poker final hand the player can make, wherein if the final hand is one of a predetermined number of winnings ranks, the player is paid for the rank of the final hand using a paytable.

The game can operate as follows. In operation 100, the machine receives a wager from a player. This is typically done by the player indicating to the machine how many credits he or she wants to bet (using buttons) and then presses a button to indicate that he or she wishes to begin a new game, upon which the number of credits bet is deducted from the player's credit meter. Initially, the player can make a cash deposit (or use a ticket/voucher, or electronic form of payment) in order to fund the credits in the machine.

From operation 100, the method proceeds to operation 102, which deals five random cards to the player. This can be considered the player's initial hand. Typically, a single standard 52 card deck is used, although in other variations, other types of decks can be used as well (e.g., decks with one or more wildcards). The five cards are typically dealt face up.

From operation 102, the method proceeds to operation 104, which allows the player to select the player's hold cards in the initial hand. The player's hold cards are cards which the player wishes to keep. Cards which are not hold cards are considered “discard cards.” The player can indicate which of the cards are hold cards by touching the desired hold cards (on a touch-screen machine) or by pressing buttons. The player can also touch a card with “hold card” status and the status can be changed to no longer be a hold card.

From operation 104, the method proceeds to operation 106, which determines whether the player draws. In order to draw, the player can press a draw button which initiates a draw. If the player does not draw, the player is free to continue to change the desired hold cards (in operation 104) until the player is satisfied with his or her choice.

Once the player draws in operation 106, the method proceeds to operation 108, which replaces all the discard cards in the initial hand (cards which are not indicated as hold cards) with newly dealt cards from the virtual deck in order to form a final hand.

From operation 110, the method proceeds to operation 112, which determines a hand rank of the final hand. This can be done by comparing the cards in the final card to determine if they meet a particular defining criteria. Table I below is an exemplary video poker paytable which comprises a list of video poker hand ranks, although it can be appreciated that different variants of video poker can use different hand ranks and payouts.

TABLE I

| Hand | payout |
|---|---|
| Royal Flush | 250 |
| Straight Flush | 50 |
| Four of a Kind | 25 |
| Full House | 9 |
| Flush | 6 |
| Straight | 4 |
| Three of a Kind | 3 |
| Two Pair | 2 |
| Jacks or Better | 1 |
| Anything else | 0 |

From operation 112, the method proceeds to operation 112 which determines if the final hand is a winning hand rank. A winning hand rank is a rank on the paytable being used that has a payout greater than 0.

If the final hand rank is a winning rank, then the method proceeds to operation 114, which pays the player based on the hand rank. The payout is determines using a respective entry in the paytable which corresponds to the winning final hand rank multiplies by the number of coins bet. The payout is typically made in the form of credits that can be cashed out for real coins, or a ticket redeemable for cash at a kiosk, when the player wishes. From operation 114, the method proceeds to operation 116, wherein the game ends.

If the final hand rank is not a winning rank, then the method proceeds to operation 116, wherein the player is not paid a payout and the game ends. Of course, the player is free to begin a new game (by pressing appropriate buttons) and start again at operation 100 if the player so wishes.

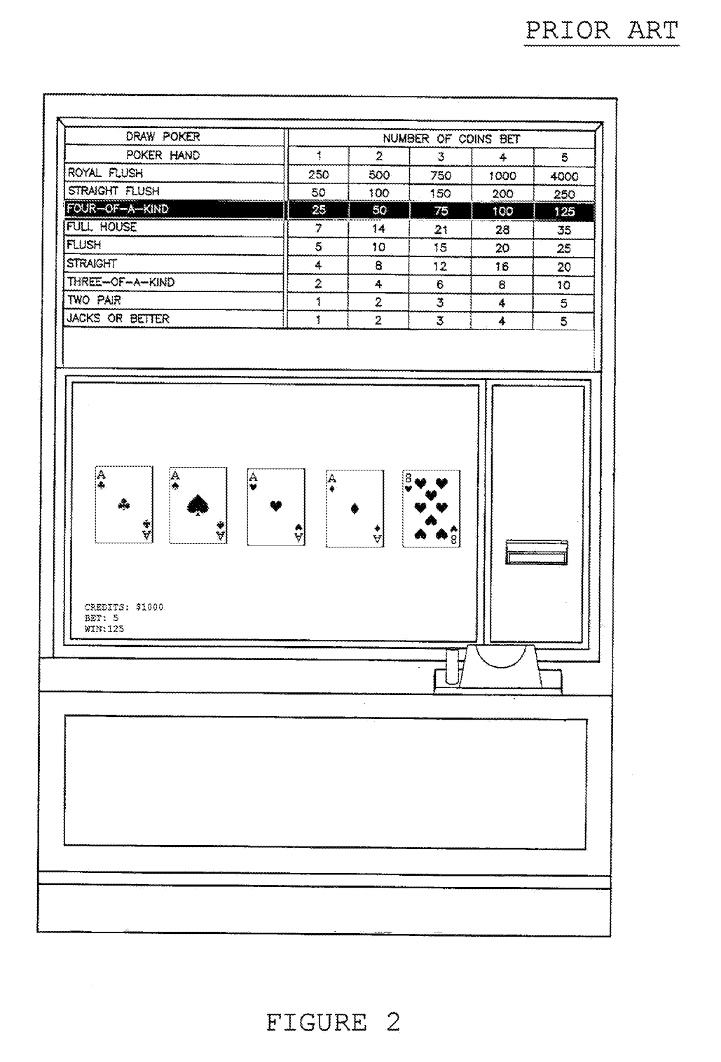

FIG. 2 is a drawing of one example of a video poker machine that can be used to implement methods herein, according to an embodiment. Of course other types of machines can be used as well, including playing over the internet using a personal computer.

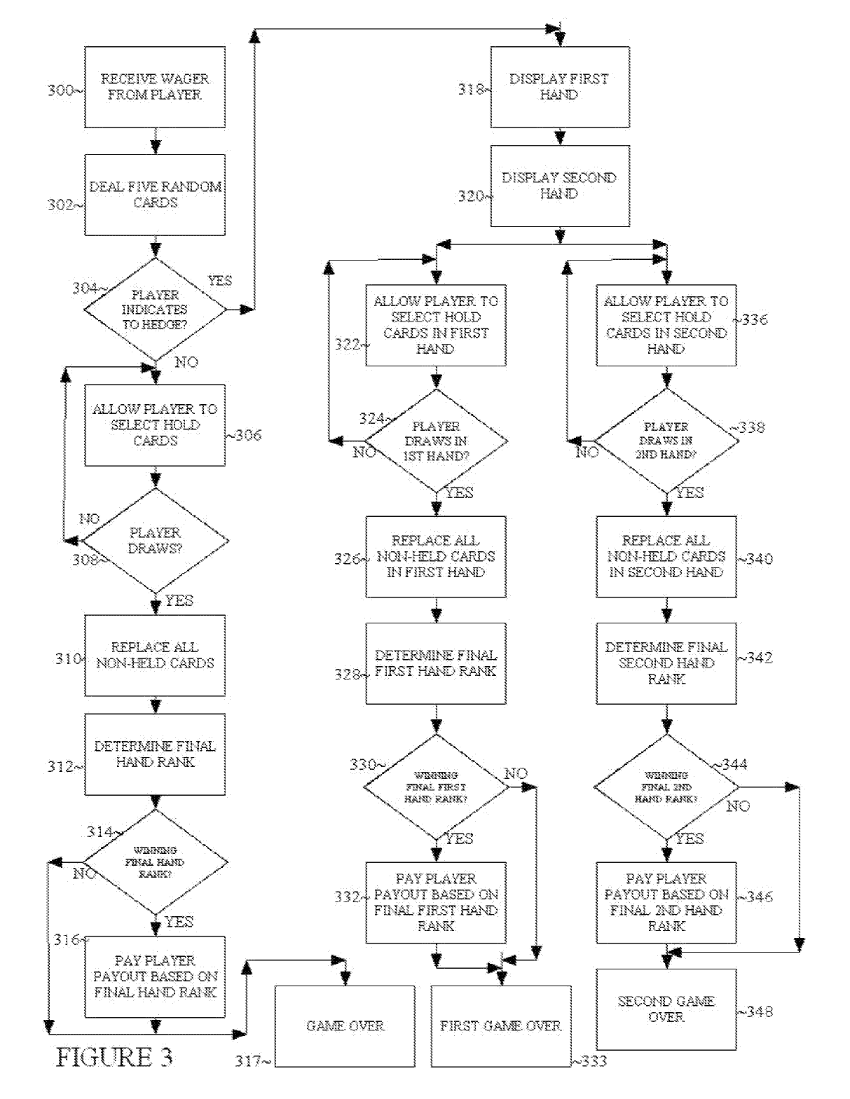

FIG. 3 is a flowchart illustrating an exemplary method of offering a hedge option during a video poker game, according to an embodiment.

The method can begin with operation 300, which receives a wager from the player. This can be done as known in the art. For example, the player has funded the video poker machine with cash (or electronic payment) which credits the credit meter with credits, each credit typically representing one coin. The player indicates how many credits he or she wishes to bet by pressing buttons (either physical or virtual), upon which that number of coins (e.g., credits) is deducted from the player's credit meter and the game begins.

From operation 300, the method proceeds to operation 302, which deals and displays five random cards face up to the player out of a virtual standard deck of cards. This is done as known in the art.

From operation 302, the method proceeds to operation 304, wherein the player can choose whether to hedge his bet or not. The player can decide whether to hedge or not after viewing the initial cards dealt in operation 302. One way the player can indicate whether he or she wishes to hedge is by pressing a hedge button which will trigger the hedge operation. If the player does not wish to hedge, the player can play normally and not press the hedge button.

From operation 304, the method proceeds to operation 306, which allows the player to select hold cards. The player can touch any combination of card(s) the player wishes to hold (which then become held cards). The player can touch a held card which will remove the card's hold status.

From operation 306, the method proceeds to operation 308, which determines whether the player draws. The player draws by pressing a draw button on the machine. If the player does not draw, then the method returns to operation 306 which allows the player to continue selecting hold cards. The method can also return to operation 304, wherein the player can still decide to hedge. If the player wants to hold all cards and not replace any, the player must still hold all cards and draw.

If in operation 308, the player draws (by pressing a draw button), the method proceeds to operation 310, which replaces all non-held cards (discards) with newly dealt cards from the deck to form a final hand.

From operation 310, the method proceeds to operation 312, which determines the rank of the final hand. This is done by comparing the cards in the final hand to see which category (rank) they fall into out of a set of possible ranks. If a hand does not fall into a winning hand category then it can have the category of “losing hand” (not a winning hand rank).

From operation 312, the method proceeds to operation 314, which determines if the final hand rank determined in operation 312 is a winning rank. During the game, a paytable is active which displays the winning ranks (and respective payouts) for the particular game being played. If the final hand rank is not a winning rank, then the method proceeds to operation 317, wherein the game is over.

If in operation 314, the final hand rank is determined to be a winning hand rank, then the method proceeds to operation 316, which pays the player a payout based on the final hand rank. The payout is determined by looking up a respective payout for the final hand rank achieved based on the number of coins bet (in operation 300). Then the method proceeds to operation 317, wherein the game ends.

It is noted that operations 300 to 317, if the player declines to hedge, implement a standard prior art video poker game. The decision to hedge (in operation 304) is what triggers the hedging feature of the present inventive concept.

If, in operation 304, the player decides to hedge (by pressing a “hedge” button), then the method proceeds to operation 318, which displays a first hand which is the same hand dealt (displayed) in operation 302. The cards in the first hand are removed from a first deck.

From operation 318, the method proceeds to operation 320, which displays a second hand which is the same hand dealt (displayed) in operation 302. The second hand can be displayed simultaneously and alongside (e.g., horizontally or vertically) the first hand. The cards in the second hand are removed from a second deck.

From operation 318, the method proceeds to operations 322 and 336 simultaneously. In other words, operations 322 and 336 can be active simultaneously, and their subsequent operations can also be triggered simultaneously. In other words, operations 322 to 332 can take place while operations 336 to 346 are taking place, neither has to occur in a particular order (i.e., the first hand and the second hand can be resolved by the player/machine in any order). Alternatively, operations 322 to 332 must take place first and then operations 336 to 346 will be performed (i.e., the first hand is resolved first, and then the second hand is resolved). Alternatively, operations 336 to 346 must take place first and then operations 322-332 will take place. Furthermore, as an alternative to a simultaneous display, the first hand can be displayed and resolved before the second hand is displayed and resolved.

From operation 320, the method proceeds to operation 322, which allows the player to select hold cards in the first hand. This is done as described above, wherein the player can touch selected cards in the first hand using a touch-screen to designate their status as hold card(s). If the player wants to hold all cards and not replace any, the player must still hold all cards and draw.

From operation 322, the method proceeds to operation 324, which determines whether the player draws in the first hand. The player can draw into the first hand by pressing a first draw button. If the player has not drawn yet, the method returns to operation 322, which allows the player to continue to indicate his or her choice of hold cards in the first hand.

If in operation 324, the player draws in the first hand, the method proceeds to operation 326, which replaces all non-held cards in the first hand with newly dealt cards from a first deck to form a final first hand.

From operation 326, the method proceeds to operation 328, which determines a rank of the final first hand. This can be done as described herein and known in the art.

From operation 328, the method proceeds to operation 330, which determines if the final first hand rank is a winning rank. If not, the method proceeds to operation 333, wherein the first game is over. The second game (operations 336-348) may still need to be resolved or it may have already been resolved.

If in operation 330 it is determined that the final first hand rank is a winning rank, then the method proceeds to operation 332, which pays the player a payout based on the final first hand rank. The payout is determined by looking up on a paytable being used a respective payout based on the first hand rank and a number of coins bet on the first hand. Typically, the number of coins bet on the first hand will be the number of coins bet in operation 300 divided by two. In other words, half of the coins bet on the game (in operation 300) will be bet on the first game, and the other half will be bet on the second game. From operation 332, the method can proceed to operation 333, which ends the first game.

From operation 320, the method also can proceed to operation 336, which allows the player to select hold cards in the second hand. This is done similarly to as described above, wherein the player can touch selected cards in the second hand using a touch-screen to designate their status as hold card(s). If the player wants to hold all cards and not replace any, the player must still hold all cards and draw.

From operation 336, the method proceeds to operation 338, which determines whether the player draws in the second hand. The player can draw into the second hand by pressing a second draw button. If the player has not drawn yet, the method returns to operation 336, which allows the player to continue to indicate his or her choice of hold cards in the second hand.

If in operation 338, the player draws in the second hand, the method proceeds to operation 340, which replaces all non-held cards in the second hand with newly dealt cards from a first deck to form a final second hand.

From operation 340, the method proceeds to operation 342, which determines a rank of the final second hand. This can be done as described herein and known in the art.

From operation 342, the method proceeds to operation 344, which determines if the final second hand rank is a winning rank. If not, the method proceeds to operation 348, wherein the second game is over. The first game (operations 322-333) may still need to be resolved or it may have already been resolved.

If in operation 344 it is determined that the final second hand rank is a winning rank, then the method proceeds to operation 346, which pays the player a payout based on the final second hand rank. The payout is determined by looking up on a paytable being used a respective payout based on the second hand rank and a number of coins bet on the second hand. Typically, the number of coins bet on the second hand will be the number of coins bet in operation 300 divided by two. In other words, half of the coins bet on the game (in operation 300) will be bet on the first game, and the other half will be bet on the second game. From operation 346, the method can proceed to operation 348, which ends the first game.

Thus, as can be seen by the method illustrated in FIG. 3, the present inventive concept offers the player a game which can be played like a standard video poker game, but it can also offer the player to hedge (split) his bet into two different halves and play the current initial hand two different ways. This can be beneficial for when players find themselves in a situation where they cannot decide which way to play a hand. For example, if the player is dealt: Jack-hearts/ten-hearts/three clubs/eight-spades/seven-clubs. One common way the player can play this hand is to hold the jack and discard the remaining cards (in the hopes of getting jacks or better). Another common way to play this hand would be to hold all cards but the three-clubs in the hopes of drawing into a straight. Now, upon seeing the initial cards, the player can press a hedge button and split the hand into two different identical hands, which the player can play in different manners. This way, the player can now play the initial hand both ways.

It is noted in FIG. 3 that the drawing (operations 326 and 340) can use a copy of the same deck. For example, the draw cards that are drawn in operation 326 are identical (in order and value) to the cards that are drawn in operation 340. Thus, whatever cards the player draws in the first draw (operation 326), the player will also draw these identical cards in the second draw (operation 340). In this embodiment, the player would not be shown the draw cards until after the player has selected the hold cards in the second hand, so that the player will not know which cards are going to be dealt out of the deck. In another embodiment, the cards dealt from the deck in operation 340 are from a completely different deck than from those dealt in operation 326. In this manner, different draw cards can come out in each of the two different hands.

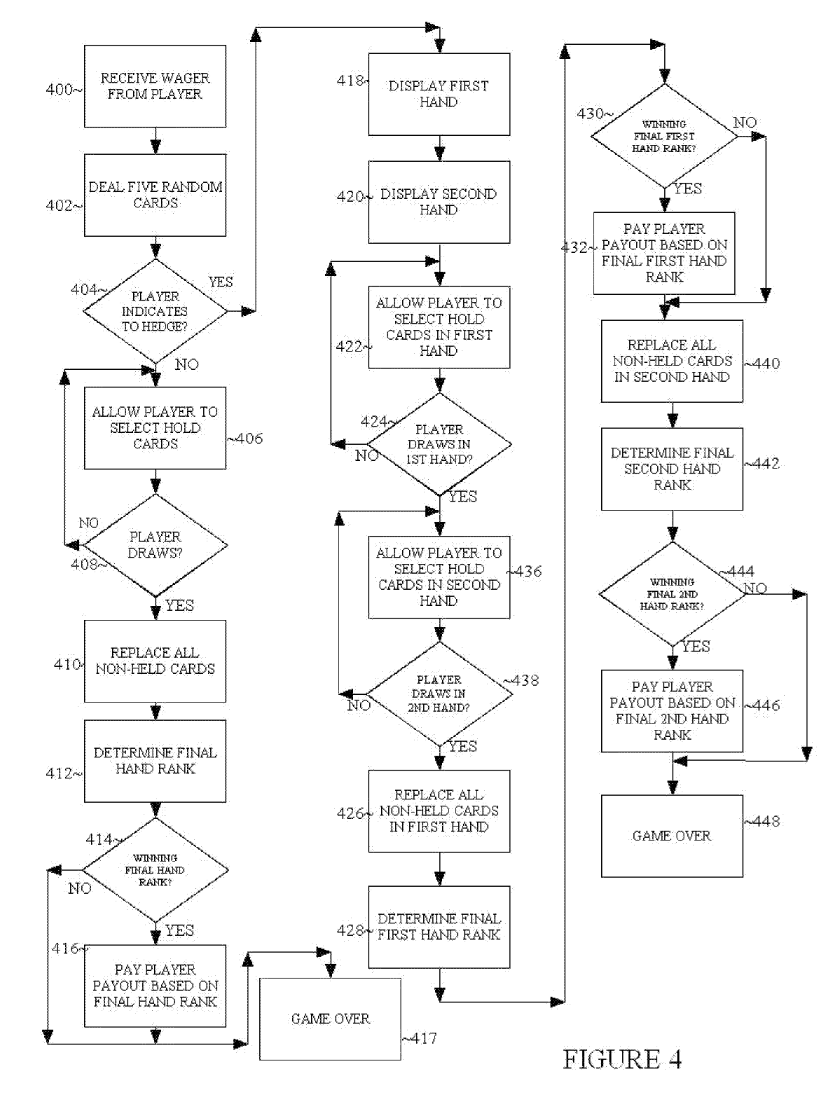

FIG. 4 is a flowchart illustrating a second exemplary method of offering a hedge option during a video poker game, according to an embodiment. The method illustrated in FIG. 4 is very similar to the method illustrated in FIG. 3, however it differs slightly in the order of operations. In FIG. 3, when the hedge operation is initiated, the first hand and the second hand can be played simultaneously. In FIG. 4, when the hedge operation is initiated, the first hand and the second hand are played sequentially. This can be preferred in the embodiment where the same draw (replacement) cards are dealt for both the first hand and the second hand, in this manner, the player will not see what the draw cards are before he or she plays the next hand. However, the method illustrated in FIG. 4 can also be applied to the embodiment that the draw cards for the first and second hands are not identical and are taken from individual decks. For a description of each of the operations in FIG. 4, see the counterpart operation in FIG. 3 (the counterpart operation in FIG. 3 having the identical number as in FIG. 4 minus 100).

In a further embodiment, operations 422, 424, 436, and 438 can be combined such that operations 422 and 436 can occur simultaneously and upon the press of a single draw button, both hands will then be drawn (the method continues to operation 426).

An example game will now be presented in order to illustrate the hedging method described herein. It will be appreciated that this is merely one example, and that there can be millions of possible unique games that can be played using the methods described herein.

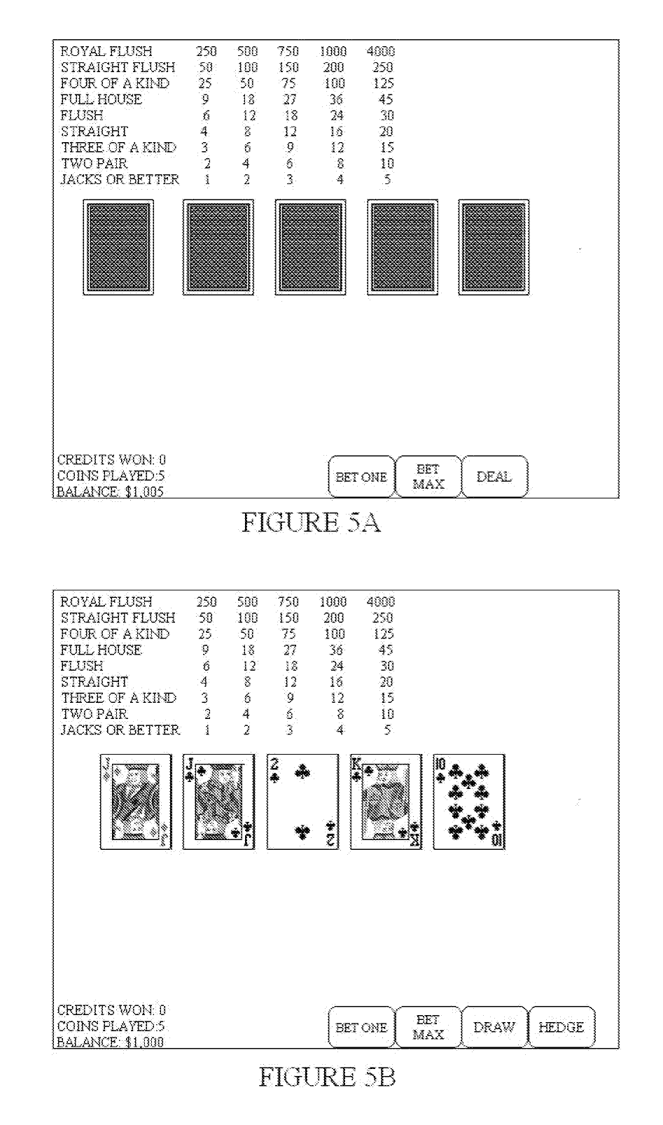

FIG. 5A is a drawing illustrating a first phase in an illustrative game, according to an embodiment.

In this figure, the player starts by betting five coins (e.g., by pressing “bet max”) and then pressing the “deal” button.

FIG. 5B is a drawing illustrating a second phase in an illustrative game, according to an embodiment.

After the player presses deal in FIG. 5A, the video poker machine deals five random cards as illustrated herein: Jack-diamonds/Jack-clubs/two-clubs/King-clubs/ten-clubs. Also note that a draw button and a hedge button have now appeared. Also note that the “bet one” and “bet max” buttons now have no function (inactive) until the game is completely over.

It is noted that this hand may be difficult for players to decide upon what to do. Some players may want to keep the pair of jacks and hope for three or even four jacks (or a full house). Other players may wish to keep the jack-clubs, king-clubs, ten-clubs and go for the royal flush. Some players may be undecided about which course of action to take. In this example, the player decided to press the “hedge” button so the player can play this hand out in two different manners.

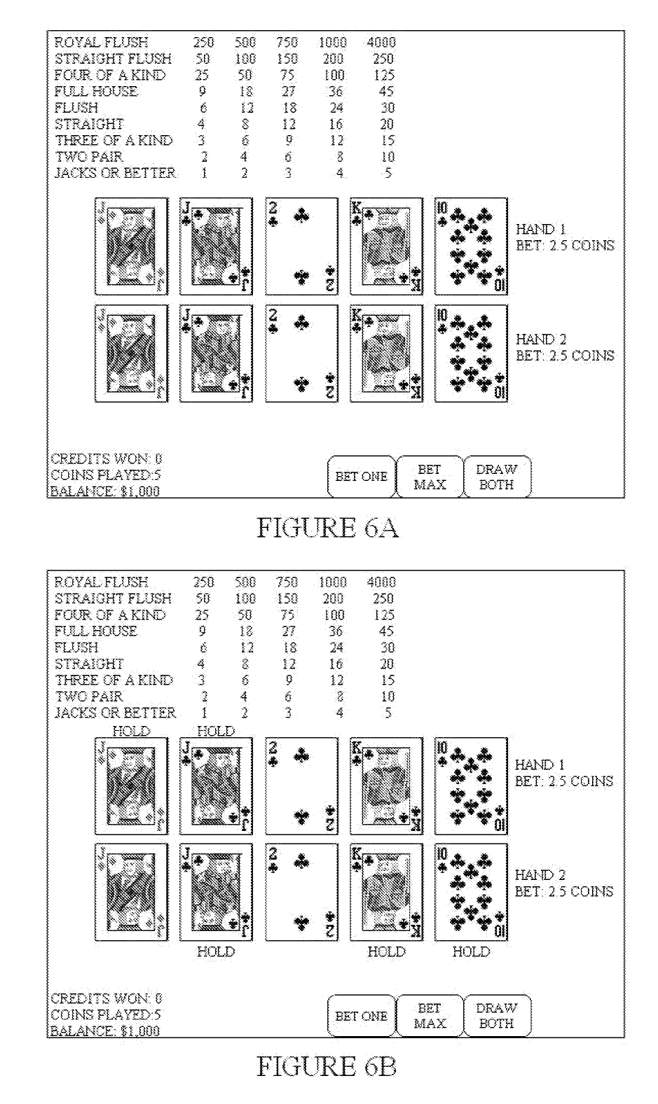

FIG. 6A is a drawing illustrating a third phase in an illustrative game, according to an embodiment.

After the player presses the “hedge” button in FIG. 5B, the video poker machine now splits the previous initial hand into two identical hands as shown in FIG. 6A. Note that while the player bet five coins on the initial (single) hand, since the player has now split the hand into two, the player has bet half of five coins, or 2.5 coins, on each of the two hands shown.

The player is also free to touch any of the cards in order to indicate the player's choice of hold cards. Cards which are not held by the player are discards (and will be replaced upon draw). If the player is happy with all five of his or her cards, then the player will hold all five cards and then draw.

FIG. 6B is a drawing illustrating a fourth phase in an illustrative game, according to an embodiment.

Note that the machine displays “HOLD” by each card that the player decides to hold. In the top (first) hand, the player has decided to hold the pair of jacks (hoping to draw more jacks). In the bottom (second) hand, the player has decided to hold the jack-clubs, king-clubs, ten-clubs (hoping to draw an ace-clubs and queen-clubs to make a royal flush).

The player now presses the “draw both” button.

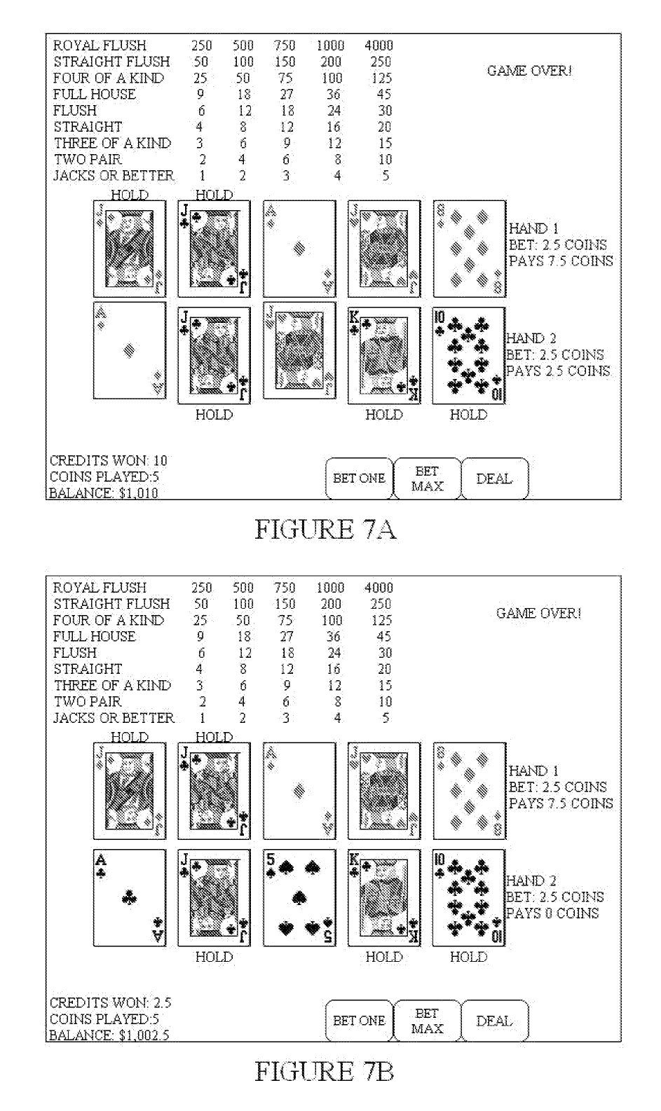

FIG. 7A is a drawing illustrating a first final phase in an illustrative game, according to an embodiment.

After the player presses the “draw both” button in FIG. 6B, the video poker machine now completes the game by replace the discarded cards with new cards. In the first hand, the replacement cards are ace-diamonds, jack-hearts, and 8-diamonds, giving the player a first hand final rank of three of a kind. According to the paytable shown in the figure, a one coin payout for three of a kind is 3 coins, so since the player has constructively bet 2.5 coins on the first (top) hand, the player wins 7.5 coins on that hand.

In the second (bottom) hand, the player has drawn an ace-diamonds and jack-hearts. The player did not get the royal flush that the player hoped for but the player at least has a second hand final rank of jacks or better. According to the paytable, jacks or better pays 1 coin for 1 coin bet, so betting 2.5 coins pays 2.5 coins. Thus, the player's total payout for both hands is 7.5 coins plus 2.5 coins equals 10 coins.

Note that in the embodiment illustrated in FIG. 7A, the draw (replacement) cards are identical in each of the two hands. The player will not know what the draw cards will actually be until the player indicates his selection of hold cards for both hands.

FIG. 7B is a drawing illustrating a second final phase in an illustrative game, according to an embodiment. FIG. 7B illustrates an embodiment wherein the draw (replacement) cards are not identical for each of the two hands. Like FIG. 7A, FIG. 7B can result from when the player presses the “draw” button in FIG. 6B.

The video poker machine deals ace-diamonds, jack-hearts, eight-diamonds as replacement (draw) cards in the top (first) hand. The final hand rank for the first hand is three of a kind, which pays 7.5 coins for a bet of 2.5 coins.

The second (bottom) hand is dealt new replacement cards which do not have to be identical to those from the top hand. This can be accomplished by using two separate decks (with the cards from the initial hand removed) for each of the first and second hands. This can also be accomplished by using a single deck for both hands, but not dealing duplicate cards into one hand that was dealt into the other (e.g., if a card is dealt as a replacement card in the top hand then it cannot be redealt as a replacement card into the bottom hand).

Thus, in this example, the bottom (second) hand is dealt cards that are unrelated to the replacement cards dealt in the top hand. The replacement cards dealt are: ace clubs and five-spades. The player did not achieve the royal flush in the bottom hand and thus the final rank of the second hand is nothing (losing hand since it is not a rank of at least jacks or better). Thus, the player is paid 7.5 coins.

It is further noted that when the player decides to implement the hedge function, the video poker machine can: 1) display an additional (second) and identical to the initial hand dealt (while keeping the initial hand dealt intact), or 2) remove the initial hand dealt and display two new hands (in a same or different location on the output device) that are identical to the initial hand (now removed). In the latter embodiment, a first of the two new hands can be considered to be the original (initial) hand that was dealt and displayed but now removed.

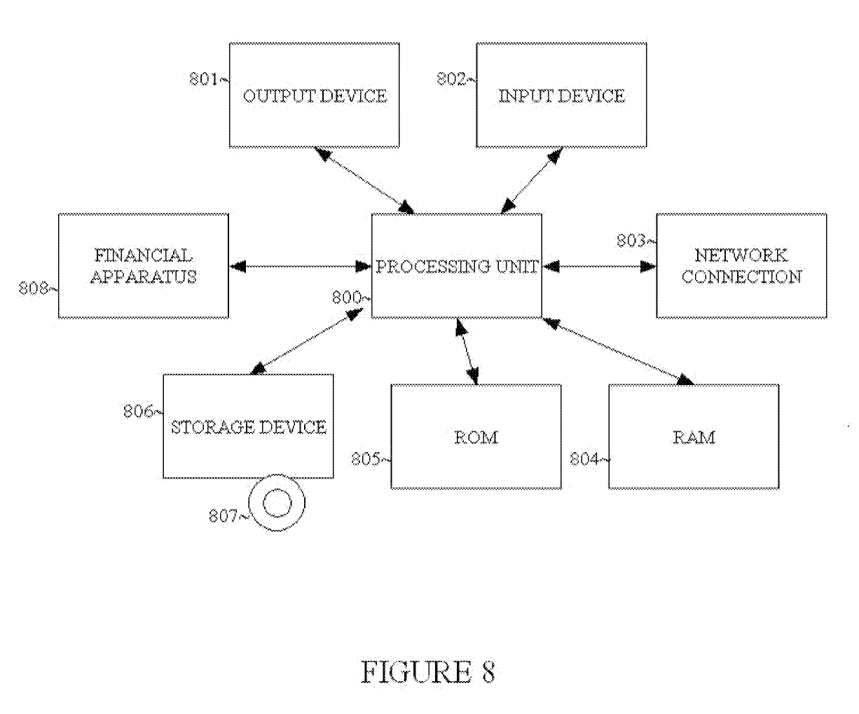

FIG. 8 is a block diagram illustrating hardware that can be used to implement the wagering methods described herein, according to an embodiment. The hardware can be, for example, an electronic gaming machine (EGM) used in casinos. The hardware can also be a personal computer, playing the game using the Internet at an Internet casino for real money.

A processing unit 800 (such as a microprocessor and any associated components) is connected to an output device 801 (such as an LCD monitor, touch screen, CRT, etc.) and an input device 802 (e.g., buttons, a touch screen, a keyboard, mouse, etc.) The output device, can for example, display results of the processing unit, such as the outputs illustrated in FIGS. 5A-7B. The processing unit 800 can also be connected to a network connection 803, which can connect the electronic gaming device to a computer communications network such as the Internet, a LAN, WAN, etc. The processing unit 800 is also connected to a RAM 804 and a ROM 805. The processing unit 800 is also connected to a storage device 806 which can be a DVD-drive, CD-ROM, flash memory, etc. A computer readable storage medium 807 can store a program which can control the electronic device to perform any of the methods described herein. The processing unit 800 can also be connected to a financial apparatus 808 which can receive cash and convert the received cash into playable credits for use by the player when playing the electronic device. When the player decides to cash out any remaining credits, the financial apparatus 808 can issue coins or a cashless ticket (voucher) for the remaining credits which is redeemable by the player.

It is noted that the methods described herein are typically played with a single deck of cards, although in other embodiments more than one deck can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Methods herein can be applied to any version of video poker, such as (but not limited to) double bonus, double double bonus, joker poker, deuces wild, etc. Methods described herein can also be applied to a casino player versus dealer poker game, wherein a player tries to make his or her best poker hand by discarding and drawing cards, and then comparing their hand against a dealer's hand.

Methods described herein can also be played on a physical table using physical cards and physical chips used to place wagers. Such physical chips can be directly redeemable for cash.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

The descriptions provided herein also include any hardware and/or software known in the art and needed to implement the operations described herein. Further, all methods described herein can be programmed on a digital computer and stored on any type of computer readable storage medium.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a video poker game, the method comprising:
providing an input unit and an output unit;
providing a processing unit operationally connected to the input unit and the output unit, the processing unit executing instructions to perform the following operations:
receiving an initial wager from a player;
dealing a player's first hand comprising five cards;
receiving an instruction by the player to duplicate the initial hand;
duplicating the first hand as a second hand;
allowing the player to select hold cards in the first hand and the second hand;
replacing non-hold cards in the first hand and the second hand with new cards to form a first final hand and a second final hand;
awarding any earned first payout, on the electronic gaming machine, to the player based on a rank of the first final hand; and
awarding any earned second payout, on the electronic gaming machine, to the player based a rank of the second final hand.

2. The method as recited in claim 1, wherein the replacing non-hold cards uses identical cards in the first hand and the second hand.

3. The method as recited in claim 1, wherein the replacing non-hold cards uses identical decks for the first hand and the second hand.

4. The method as recited in claim 1, wherein the replacing non-hold cards uses a same deck for the first hand and the second hand.

5. The method as recited in claim 1, wherein the replacing non-hold cards uses a different deck for the first hand and the second hand.

6. The method as recited in claim 1, wherein the awarding any earned first payout is based on half of the initial wager.

7. The method as recited in claim 1, wherein the awarding any earned second payout is based on half of the initial wager.

8. A method to play a video poker game, the method comprising:
providing an input unit and an output unit;
providing a processing unit operationally connected to the input unit and the output unit, the processing unit executing instructions to perform the following operations:
receiving an initial wager from a player;
dealing a player's initial hand comprising five cards;
receiving an instruction by the player to duplicate the initial hand;
copying the initial hand as a first hand, and copying the initial hand as a second hand;
allowing the player to select hold cards in the first hand and the second hand;
replacing non-hold cards in the first hand and the second hand with new cards to form a first final hand and a second final hand;
awarding any earned first payout, on the electronic gaming machine, to the player based on a rank of the first final hand; and
awarding any earned second payout, on the electronic gaming machine, to the player based a rank of the second final hand.

9. An apparatus to play a video poker game, the method comprising:
an input unit and an output unit;
a processing unit operationally connected to the input unit and the output unit, the processing unit executing instructions to perform the following operations:
receiving an initial wager from a player;
dealing a player's first hand comprising five cards;
receiving an instruction by the player to duplicate the initial hand;
duplicating the first hand as a second hand;
allowing the player to select hold cards in the first hand and the second hand;
replacing non-hold cards in the first hand and the second hand with new cards to form a first final hand and a second final hand;
awarding any earned first payout, on the electronic gaming machine, to the player based on a rank of the first final hand; and
awarding any earned second payout, on the electronic gaming machine, to the player based a rank of the second final hand.

10. The apparatus as recited in claim 9, wherein the replacing non-hold cards uses identical cards in the first hand and the second hand.

11. The apparatus as recited in claim 9, wherein the replacing non-hold cards uses identical decks for the first hand and the second hand.

12. The apparatus as recited in claim 9, wherein the replacing non-hold cards uses a same deck for the first hand and the second hand.

13. The apparatus as recited in claim 9, wherein the replacing non-hold cards uses a different deck for the first hand and the second hand.

14. The apparatus as recited in claim 9, wherein the awarding any earned first payout is based on half of the initial wager.

15. The apparatus as recited in claim 9, wherein the awarding any earned second payout is based on half of the initial wager.
